(19) United States
(12) Patent Application Publication
(10) Pub. No.: US 2012/0230525 A1
(43) Pub. Date: Sep. 13, 2012

(54) AUDIO DEVICE AND AUDIO SYSTEM

(75) Inventors: Satoshi Higuchi, Kanagawa (JP); Takayuki Niitsuma, Chiba (JP); Akihito Masumura, Kanagawa (JP)

(73) Assignee: SONY CORPORATION, Tokyo (JP)

(21) Appl. No.: 13/409,541

(22) Filed: Mar. 1, 2012

(30) Foreign Application Priority Data
Mar. 11, 2011 (JP) 2011-054712

(51) Int. Cl. H04R 5/02

(52) U.S. Cl. 381/303

(57) ABSTRACT

An audio device includes: a reproduction unit that reproduces an audio signal of a plurality of channels; an input unit that receives a detection signal indicating the positions of the reproduction unit and a listener; and a control unit that changes the audio signal to be reproduced by the reproduction unit depending on the position based on the detection signal.

### CROSS-REFERENCE TO RELATED APPLICATION

The present application claims priority from Japanese Patent Application No. JP 2011-054712 filed in the Japanese Patent Office on Mar. 11, 2011, the entire content of which is incorporated herein by reference.

### FIELD

The present disclosure relates to an audio device and an audio system which are applied, for example, for surround reproduction.

### BACKGROUND

A surround-sound system reproducing an audio with an excellent realistic sensation is known. In the surround-sound system, 5.1ch (channel), 7.1ch (channel), and the like are known. In the 5.1ch, a speaker arrangement in which three channels of speakers are arranged on the front side and two channels of speakers are arranged on the rear side is used.

A front surround-sound system reproducing a surround sound using only plural front speakers is also known. A front surround-sound system using three speakers is referred to as 3.1ch and a front surround-sound system using two speakers is referred to as 2.1ch. An audio system having a rack function of placing a television receiver thereon and a front surround reproduction function is practically used. Such a type of audio system has an AV amplifier and plural speakers built therein, and has an advantage of easy connection and installation.

In the surround-sound systems, the positions of speakers and the position of a listener have to have a predetermined relationship so as to achieve an excellent realistic sensation. For example, when a listener is located at a reference listening position (referred to as reference position) apart by a predetermined distance from the front of a speaker, it is possible to reproduce an excellent surround sound. However, when the position of the listener is not the reference position, the setting of a level and a phase is not optimal and a desired realistic sensation is not achieved.

Japanese Patent No. 4225307 discloses that the output of an audio signal from a speaker attached to a television receiver is controlled on the basis of the positional relationship between the television receiver and a viewer. Specifically, a volume level is changed depending on the distance between the television receiver and the viewer. It is also disclosed that the volume level is adjusted depending on the lateral position.

### SUMMARY

Japanese Patent No. 4225307 mentions that a volume is adjusted but does not mention that the reproduction of a surround sound is improved regardless of the position (distance and angle) of a listener. In Japanese Patent No. 4225307, the level of an audio signal to be supplied to a speaker built in a television receiver having a viewer position detecting function is controlled, but an audio system installed separately from the television receiver is not controlled. The speaker built in the television receiver has a problem in which the size thereof is limited and a low sound is not reproduced. Accordingly, a speaker disposed separately from the television receiver is preferably used to reproduce a high-quality sound.

Thus, it is desirable to provide an audio device and an audio system which can detect the position of a listener by the use of another device and can reproduce an excellent surround sound regardless of the position of the listener.

An embodiment of the present disclosure is directed to an audio device including: a reproduction unit that reproduces an audio signal of a plurality of channels; an input unit that receives a detection signal indicating the positions of the reproduction unit and a listener; and a control unit that changes the audio signal to be reproduced by the reproduction unit depending on the positions based on the detection signal.

Preferably, the control unit may calculate a target value of a level and/or an amount of delay of the audio signal on the basis of the position and may change the level and/or the amount of delay of the audio signal using a difference between the target value and a current value as an amount of adjustment.

Another embodiment of the present disclosure is directed to an audio system including: a sensor that detects a position of a listener; a position detecting unit that processes the output of the sensor and outputs a detection signal indicating the position; a reproduction unit that reproduces an audio signal of a plurality of channels; an input unit that receives the detection signal from the position detecting unit; and a control unit that changes the audio signal to be reproduced by the reproduction unit depending on the position based on the detection signal.

Preferably, the position detecting unit may be constructed by an imaging unit disposed in a video display device located substantially at the same position as the reproduction unit.

According to the embodiments of the present disclosure, since the position of a listener is detected by the use of another device, it is possible to construct a relatively simple configuration not having a detector. It is also possible to reproduce an excellent surround sound as well as to control the volume level.

### BRIEF DESCRIPTION OF THE DRAWINGS

FIG. 1 is a diagram illustrating the appearance of an audio system according to an embodiment of the present disclosure.

FIG. 2 is a diagram schematically illustrating the details of a manipulation area disposed in a theater stand.

FIG. 3 is a block diagram schematically illustrating the connection configuration of the audio system.

FIG. 4 is a block diagram illustrating an example of a television receiver.

FIG. 5 is a block diagram schematically illustrating an example of an AV amplifier.

FIG. 6 is a diagram illustrating an example of a picture of a graphical user interface used to set an automatic viewer position control.

FIG. 7 is a diagram schematically illustrating an example of a picture of a graphical user interface described in English.

FIG. 8 is a block diagram illustrating the configuration generating viewer position information.

FIGS. 9A and 9B are diagrams schematically illustrating the detection of viewer position information.

FIGS. 10A, 10B, and 10C are diagrams schematically illustrating the detection of viewer position information.

FIG. 11 is a diagram schematically illustrating the data structure when the viewer position information is transmitted via an HDMI-CEC line.

FIG. 12 is a diagram schematically illustrating an example of the viewer position information.

FIG. 13 is a diagram schematically illustrating the control of right-left balance.

FIG. 14 is a diagram schematically illustrating the control of right-left balance.

FIG. 15 is a diagram schematically illustrating the control of right-left balance.

FIG. 16 is a diagram schematically illustrating a display of balance.

FIG. 17 is a diagram illustrating a table in which operations are collectively shown in correlation with the manipulations.

FIG. 18 is a flowchart illustrating the flow of processes when receiving a command.

FIG. 19 is a flowchart illustrating the flow of regular processes for each second.

FIG. 20 is a flowchart illustrating the flow of processes when switching the setting of HDMI device control.

FIG. 21 is a flowchart illustrating the flow of processes when the television receiver is turned on.

FIG. 22 is a flowchart illustrating the flow of processes when the AV amplifier is turned on.

FIG. 23 is a flowchart illustrating the flow of processes when no person is detected.

FIG. 24 is a flowchart illustrating the flow of processes when position information is not notified.

FIG. 25 is a flowchart illustrating the flow of processes when the setting of HDMI device control of the AV amplifier is turned off.

### DETAILED DESCRIPTION

Hereinafter, embodiments of the present disclosure will be described with reference to the accompanying drawings. The embodiments described below are only specific examples and various technically preferable limitations are applied thereto, but the scope of the present disclosure is not limited to the embodiments unless otherwise stated.

### <Outline of System>

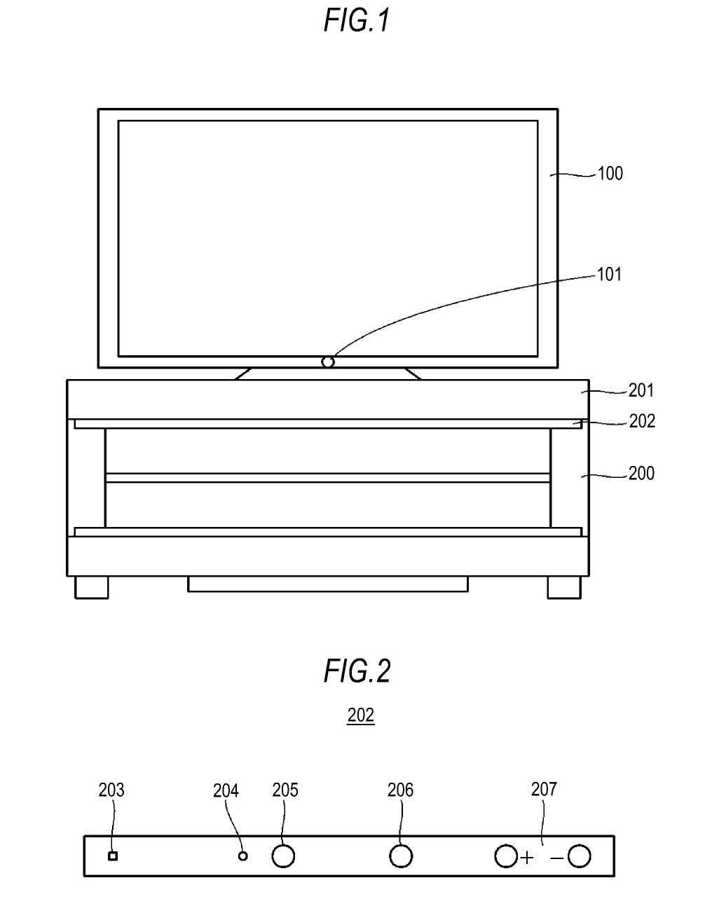

As shown in FIG. 1, an embodiment of the present disclosure employs a front surround type audio device (hereinafter, referred to as a theater stand) 200 having a configuration of a rack on which a television receiver 100 as an image display device can be placed and including an AV amplifier and plural speakers which are incorporated into a body. The theater stand 200 is, for example, of a 3.1ch front surround type. The television receiver 100 and the theater stand 200 are connected to each other via an HDMI (High-Definition Multimedia Interface).

The HDMI is a digital interface transmitting a baseband signal including a video (moving image) signal and an audio signal accompanying the video at a high speed. The standard of the HDMI is a standard which is arranged for an AV (Audio Visual) device by adding an audio transmitting function or a copyright protecting function to the DVI (Digital Visual Interface) standard which is a connection standard of a PC (Personal Computer) and a display.

The devices connected via the HDMI are classified into three types of an HDMI source, an HDMI sink, and an HDMI repeater. The HDMI source includes an output terminal for outputting a video signal or an audio signal and the HDMI sink includes an input terminal for inputting a video signal or an audio signal via the HDMI. The HDMI repeater includes one or more input terminals and one or more output terminals, serves as both the HDMI source and the HDMI sink, and relays communications between the HDMI source and the HDMI sink.

The HDMI includes a signal channel used to transmit a baseband video or audio signal in one direction from the HDMI source to the HDMI sink via a necessary HDMI repeater. The HDMI includes a CEC (Consumer Electronics Control) line as a control channel used to transmit a control signal (message) used for control of the HDMI source, the necessary HDMI repeater, and the HDMI sink in two directions. The control systems are mutually controlled via the CEC line.

For example, in the audio system shown in FIG. 1, the television receiver 100 serves as the HDMI sink, and the theater stand (AV amplifier) 200 serves as the HDMI repeater. Further, as the HDMI source, a BD (Blue-ray Disc™) recorder and the like are connected thereto. The devices constituting such an AV system correspond to the CECs and perform interlinking operations in response to the reproduction manipulation in the BD recorder or the turn-off manipulation or the selection manipulation in the television receiver.

A multi-channel PCM signal can be transmitted via the HDMI. The AV amplifier of the theater stand 200 receives a high-quality audio signal such as LPCM 7.1ch from the BD recorder, outputs an audio, and transmits a video signal of the HDMI signals to the television receiver 100. The AV amplifier of the theater stand 200 may be configured not to output an audio from itself but to transmit the input signal to the television receiver 100, in a turn-on waiting state (standby state) or the like. At this time, the HDMI signals are supplied from the BD recorder to the television receiver 100 via the AV amplifier.

In the frame around a display screen on the front surface of the television receiver 100, a sensor 101 is disposed at the center of the lower part. Although not shown in the drawing, a remote controller light-receiving part, a power lamp, and the like are disposed on the front surface, similarly to the sensor 101. The sensor 101 is a video camera and captures an image of a viewer in a predetermined range of the front side of the television receiver 100. The face of a viewer is recognized by processing the captured image. The television receiver 100 has a function of receiving digital television broadcast and a function of displaying reproduced signals from devices such as other BD recorders.

The theater stand 200 includes a shelf board on which the devices such as the BD recorder are placed and plural speakers are disposed in an upper space 201. For example, in a 2.1ch front surround-sound system, a Lch (left channel) speaker, an Rch (right channel) speaker, and a subwoofer are disposed. In a 3.1ch front surround-sound system, a Cch (center channel) speaker is added. The outputs of the speakers are radiated from the upper space 201.

A manipulation area 202 is disposed below the upper space 201. As shown in FIG. 2, the manipulation area 202 includes a remote controller light-receiving part 203, a power lamp 204, a power button 205, an input change button 206, and a volume control button 207. The television receiver 100 and the theater stand 200 are connected to each other on the rear surfaces thereof via an HDMI cable.

### <Connection of System>

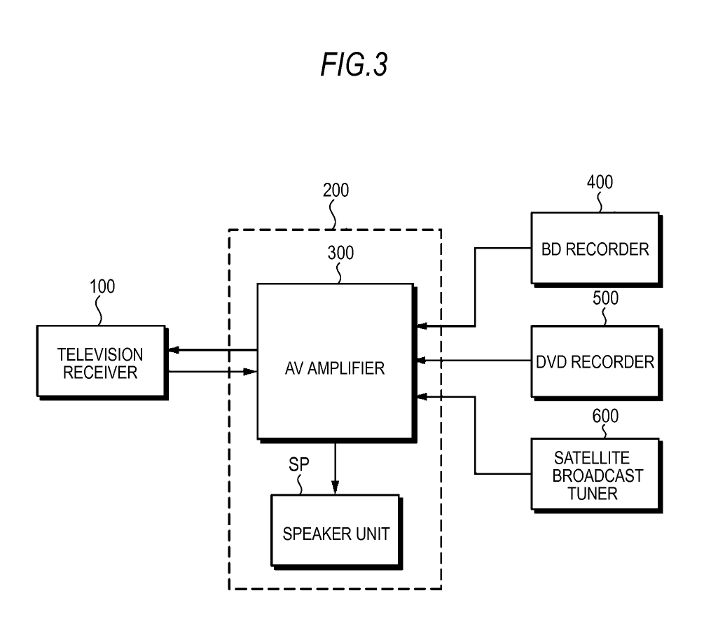

An example of an AV system is shown in FIG. 3. The AV system includes a television receiver 100, a theater stand 200, a BD recorder 400, a DVD recorder 500, and a satellite broadcast tuner 600. The theater stand 200 includes an AV amplifier 300 and a speaker unit SP. The BD recorder 400, the DVD recorder 500, and the satellite broadcast tuner 600 are disposed on the shelf board of the theater stand 200.

The television receiver 100, the AV amplifier 300, the BD recorder 400, the DVD recorder 500, and the satellite broadcast tuner 600 are HDMI-CEC compatible devices (hereinafter, simply referred to as CEC compatible devices). In the AV system shown in FIG. 3, the television receiver 100 and the AV amplifier 300 are connected to each other via an HDMI cable, and the AV amplifier 300, the BD recorder 400, the DVD recorder 500, and the satellite broadcast tuner 600 are connected to each other via HDMI cables.

The television receiver 100 and the AV amplifier 300 are also connected to each other via an optical cable. The television receiver 100 supplies an optical digital audio signal to the AV amplifier 300 via the optical cable. Specific physical addresses are allocated to the CEC compatible devices. The speaker unit SP is connected to the AV amplifier 300. The speaker unit SP includes speakers located on the front-right side, the front-left side, and the center of a viewer and a subwoofer speaker for outputting low sound so as to realize a 3.1ch front surround-sound system.

In the AV system shown in FIG. 3, when the mode (system audio mode) in which the AV amplifier 300 outputs an audio is turned on, the AV amplifier 300 receives an HDMI signal from the BD recorder 400 or the like and transmits only a video signal of the HDMI signal to the television receiver 100. When the system audio mode is turned off, the AV amplifier 300 receives an HDMI signal from the BD recorder 400 or the like and transmits the HDMI signal from the BD recorder 400 or the like to the television receiver 100 without any change.

In the AV system shown in FIG. 3, the television receiver 100, the AV amplifier 300, the BD recorder 500, the DVD recorder 500, and the satellite broadcast tuner 600 perform operations based on a CEC message which is a control signal transmitted and received via the CEC line in accordance with the manipulations in the HDMI devices.

### <Configuration Example of Television Receiver>

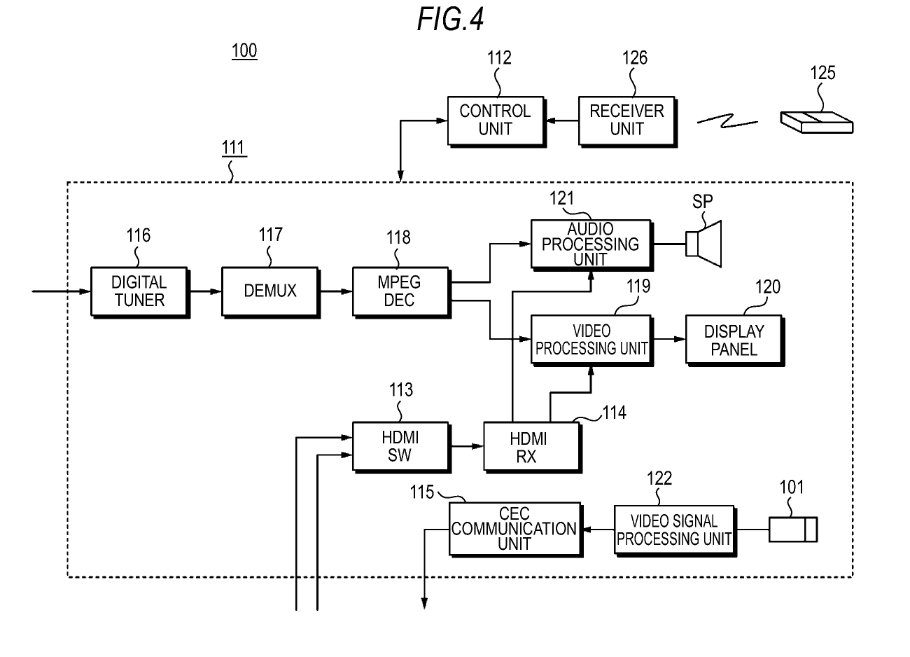

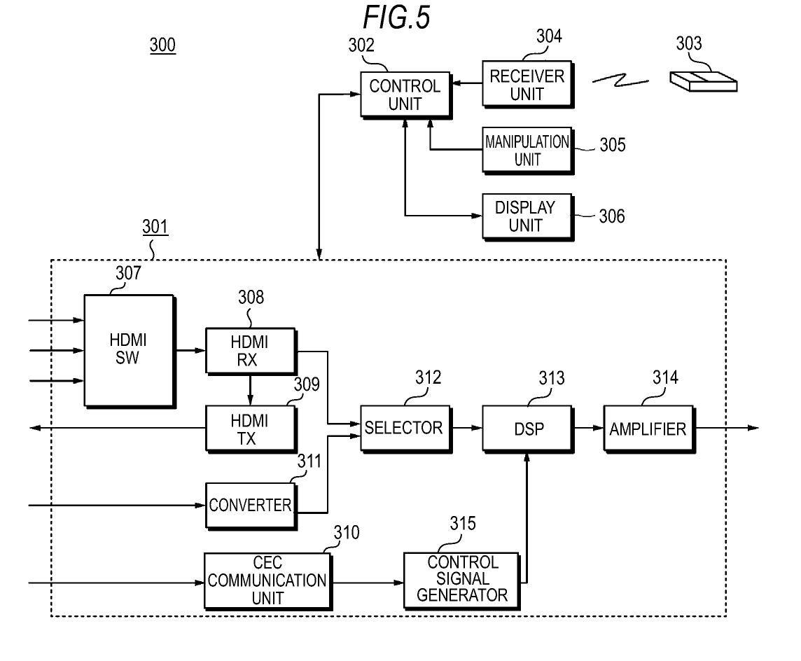

The configuration example of the television receiver 100 will be described below with reference to FIG. 4. The television receiver 100 shown in FIG. 4 includes a control object unit 111 and a control unit 112. The control object unit 111 performs various functions of the television receiver 100 under the control of the control unit 112. The control unit 112 receives the control signal from a receiver unit 126 receiving a remote control signal, for example, from a remote controller 125 and performs a control corresponding to the manipulations.

The control object unit 111 includes an HDMI switcher 113, an HDMI receiver 114, a CEC communication unit 115, a digital tuner 116, a demultiplexer 117, an MPEG (Moving Picture Expert Group) decoder 118, a video processing unit 119, a display panel 120, an audio processing unit 121, a speaker unit SP, and a captured image signal processing unit 122 processing a captured image signal from the sensor 101. The control unit 112 has a configuration in which a CPU (Central Processing Unit), a flash ROM, and a DRAM (Dynamic Random Access Memory) are connected to each other via an internal bus.

The HDMI switcher 113 selectively connects two HDMI terminals not shown to the HDMI receiver 114. The HDMI receiver 114 is connected to one of two HDMI terminals not shown via the HDMI switcher 113. The HDMI receiver 114 receives baseband video and audio signals (HDMI signals) transmitted from an external device (HDMI source or HDMI repeater) connected to two HDMI terminals by communications based on the HDMI. The HDMI receiver 114 supplies the video signal out of the received HDMI signals to the video processing unit 119 and supplies the audio signal out of the received HDMI signals to the audio processing unit 121.

The CEC communication unit 115 transmits and receives a CEC message via the CEC line to and from the HDMI repeater or the HDMI source under the control of the control unit 112. For example, viewer position information acquired by processing the captured image signal from the sensor 101 is supplied as the CEC message to the AV amplifier 300 of the theater stand 200 via the HDMI cable. The viewer position information is a detection signal indicating the distance between the speaker as the reproduction unit and a listener and the angle of the speaker about the front axis of the speaker.

The digital tuner 116 processes a television broadcast signal input from an antenna terminal not shown and supplies a predetermined TS (Transport Stream) corresponding to a channel selected by a user to the demultiplexer 117. The demultiplexer 117 extracts partial TSs (a TS packet of a video signal and a TS packet of an audio signal) corresponding to the channel selected by the user from the TS supplied from the digital tuner 116 and supplies the extracted partial TS to the MPEG decoder 118.

The demultiplexer 117 extracts PSI1/SI (Program Specific Information/Service Information) from the TS supplied from the digital tuner 116 and supplies the extracted information to the control unit 112. Plural channels are multiplexed in the TS supplied from the digital tuner 116. The process of causing the demultiplexer 117 to extract the partial TS of an arbitrary channel from the TS is enabled by acquiring information of the packet ID (PID) of the arbitrary channel from the PSI1/SI (PAT/PMT).

The MPEG decoder 118 performs a decoding process, supplies a video signal obtained as a result to the video processing unit 119, and supplies an audio signal to the audio processing unit 120. The video processing unit 119 includes a panel driving circuit and drives the display panel 120 to display a video. The display panel 120 is constructed, for example, by an LCD (Liquid Crystal Display). The audio processing unit 121 includes a D/A converter and an audio amplifier and supplies an amplified analog audio signal to the speaker unit SP.

The receiver unit 126 receives a remote control signal transmitted from the remote controller 125 and supplies the received remote control signal to the control unit 112. A user can manipulate the television receiver 100 and other CEC compatible devices connected to the television receiver 100 via the HDMI cables by manipulating the remote controller 125.

### <Configuration Example of AV Amplifier>

The specific configuration example of the AV amplifier 300 will be described with reference to FIG. 5. The AV amplifier 300 shown in FIG. 5 includes a control object unit 301 and a control unit 302. The control object unit 301 performs various functions of the AV amplifier 300 under the control of the control unit 302. The control unit 302 receives a control signal from a receiver unit 304 receiving, for example, a remote control signal from a remote controller 303 and performs a control corresponding to the manipulation. A manipulation unit 305 and a display unit 306 are disposed in association with the control unit 302.

The manipulation unit 305 includes a power button, an input changing button, and a volume control button. The display unit 306 is, for example, an LCD disposed on the top of a rack and displays a set volume, a selected input and mode, and the like.

The control object unit 301 includes an HDMI switcher 307, an HDMI receiver 308, an HDMI transmitter 309, a CEC communication unit 310, a converter 311, a selector 312, a DSP (Digital Signal Processor), an audio amplifier 314, and a control signal generator 315. The control unit 302 has a configuration in which a CPU (Central Processing Unit), a flash ROM, a DRAM (Dynamic Random Access Memory), and the like are connected to each other via an internal bus.

When the system audio mode is turned off, the HDMI switcher 307, the HDMI receiver 308, and the HDMI transmitter 309 receive the HDMI signal from the BD recorder 400 and transmit the HDMI signal from the BD recorder 400 to the television receiver 100 without any change.

The HDMI switcher 307 selectively connects plural HDMI terminals not shown to the HDMI receiver 308. The HDMI receiver 308 is connected to one of the plural HDMI terminals not shown via the HDMI switcher 307. The HDMI receiver 308 receives baseband video and audio signals (HDMI signals) transmitted in one direction from an external device (HDMI source) connected to the plural HDMI terminals not shown by communications based on the HDMI. The HDMI receiver 308 supplies the audio signal out of the received HDMI signals to the selector 312 or supplies the received HDMI signals to the HDMI transmitter 309 without any change. The HDMI transmitter 309 transmits the baseband video and audio signals (HDMI signals) supplied from the HDMI receiver 308 from the HDMI terminals not shown by communications based on the HDMI.

The CEC communication unit 310 transmits and receives a CEC message via the CEC line to and from the HDMI sink or the HDMI source under the control of the control unit 302. For example, the viewer position information transmitted as the CEC message from the television receiver 100 is supplied to the CEC communication unit 310 via the HDMI cable. The control signal generator 315 generates a control signal using the received viewer position information. The control signal is supplied to the DSP 313. The control signal is a signal used to change an audio signal to be reproduced by a speaker depending on the distance between the speaker and the viewer. Examples where the audio signal is changed by the DSP 313 include adjustment of the level of an audio signal to be supplied to the right and left speakers and/or adjustment of the phase of the audio signal to be supplied to the right and left speakers.

The converter 311 generates a digital audio signal and a clock signal of predetermined formats from the digital optical signal input from an optical input terminal not shown and supplies the digital audio signal and the clock signal to the selector 312. The selector 312 selects an audio signal supplied from the HDMI receiver 308 and an audio signal supplied from the converter 311 and supplies the selected audio signal to the DSP 313.

The DSP 313 processes the audio signal supplied from the selector 312. The DSP 313 performs, for example, a process of generating audio signals of channels for realizing the 3.1ch front surround-sound system and a process of converting a digital signal into an analog signal. The analog audio signal from the DSP 313 is supplied to the amplifier 314. The amplifier 314 amplifies the front-left audio signal, the front-right audio signal, and the subwoofer audio signal and outputs the amplified audio signals to an audio output terminal not shown. The audio output terminal not shown is connected to the front-left speaker, the front-right speaker, and the subwoofer speaker constituting the speaker unit SP.

The DSP 313 is controlled by the control signal from the control signal generator 315, when it performs a process of generating audio signals of the channels for realizing the front surround-sound system. That is, the control signal changes the level and/or the amount of delay of the audio signals to be reproduced by the speakers depending on the distance between the speakers and the viewer indicated by the viewer position information.

The configurations of the BD recorder 400, the DVD recorder 500, and the satellite broadcast tuner 600 are the same as in the related art and thus will not be repeatedly described.

### <Setting in Television Receiver>

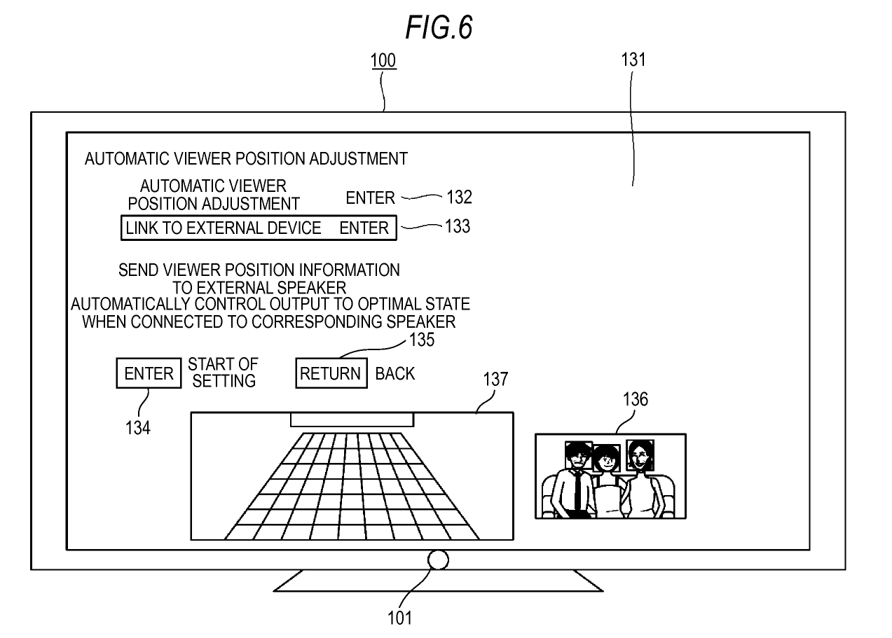

The television receiver 100 is provided with a setting menu turning on/off the functions of outputting the detected viewer position information signal to the AV amplifier 300 via the CEC communication unit 115 and automatically adjusting a viewer position. FIG. 6 shows a picture of a graphical user interface of the setting menu. This menu picture is displayed on the screen of the television receiver 100. The menu picture shown in FIG. 6 may be displayed to overlap with a displayed video.

A home button of the remote controller 125 in the television receiver 100 is pushed to display a menu setting picture 131 for automatic adjustment of a viewer position. The picture 131 includes an ON/OFF selection display part 132 of an automatic viewer position adjustment function, an ON/OFF selection display part 133 of an external device linking function, an enter button 134, and a return button 135. The selection of these buttons are performed by manipulating direction keys of the remote controller 125 and the selection is determined when the enter button is pushed.

A display window 136 of a captured image captured by the sensor 101 and a display window 137 of a viewer position are displayed. In the display window 136 of the captured image, a face position of the detected viewer is marked by a rectangular. In the display window 137 of the viewer position, the detected viewer position is marked, for example, by a white circle.

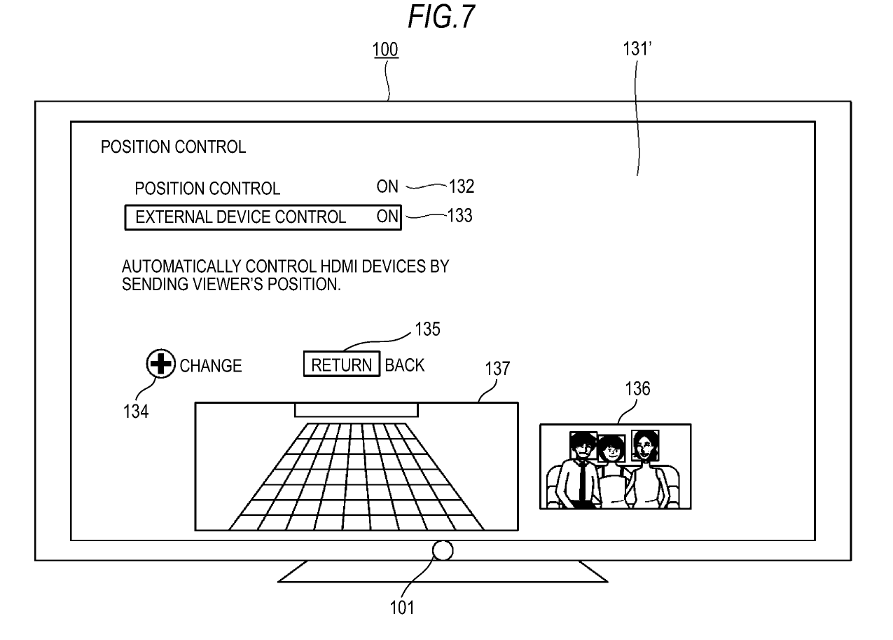

FIG. 6 is an example of a Japanese description. An example of a setting picture 131′ described in other language, for example, in English, is shown in FIG. 7. Display items corresponding to those in FIG. 6 are referenced by like reference signs.

### <Detection of Viewer Position>

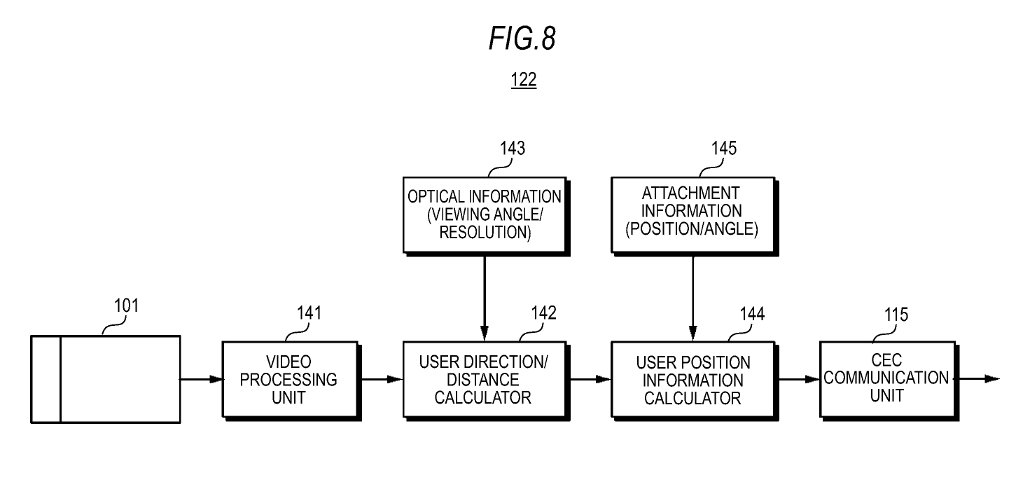

The television receiver 100 acquires a viewer position information signal by causing the captured image signal processing unit 122 to process the captured image signal from the sensor 101, and transmits the viewer position information signal to the CEC communication unit 310 of the AV amplifier 300 of the theater stand 200 from the CEC communication unit 115 via the HDMI cable. An example of the captured image signal processing unit 122 will be described with reference to FIG. 8.

The captured image signal (video signal) of the sensor 101 is supplied to the image processing unit 141. The image processing unit 141 performs an image process on the captured video signal. That is, the video processing unit 141 performs a process of detecting a face and a facial expression included in the captured image. The result of the video process of the video processing unit 141 is supplied to a user direction/distance calculator 142. The output of the user direction/distance calculator 142 is supplied to a user position information calculator 144. A user means a viewer of the television receiver 101.

The face detecting process in the video processing unit 141 employs known methods. The face detecting process will be described below in brief. When it is intended to detect a face from an image, a face position, a face size, and a face direction in the supplied image are first detected. The face part can be cut out from the image by detecting the face position and the face size. A face feature part (face feature position) is detected from the cut face part and the face direction information. Examples of the face feature part include an eyebrow, eyes, a nose, and a mouth. For example, a method called as AAM (Active Appearance Models) is used to detect the face feature position.

When it is intended to detect the face feature position, local feature quantities of the detected face feature positions are calculated. By calculating the local feature quantities and storing the calculated local feature quantities in correlation with the face image, it is possible to identify a face from an image captured by the sensor 101. Techniques disclosed in JP-A-2007-65766 and JP-A-2005-44330 can be used as the face identifying method.

The user direction/distance calculator 142 receives the result of the video process in the video processing unit 141 and optical information 143 such as a viewing angle of a camera of the sensor 101 and information of a resolution thereof and calculates the relative position (direction [φ1, φ1] and distance d1) of a user relative to the optical axis of the sensor 101.

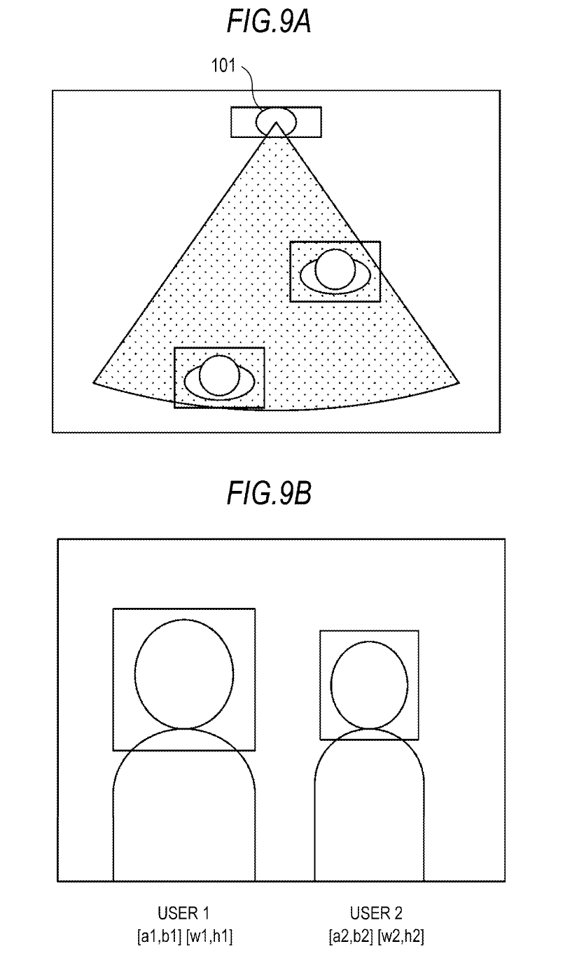

FIG. 9A shows an example where two users are present in a position detecting area set in an imaging range of the sensor 101. FIG. 9B shows face detection positions and face sizes of the users in the image captured by the sensor 101. The face detection position [a1, b1] and the face size [w1, h1] of one user (referred to as user 1) and the face detection position [a2, b2] and the face size [w2, h2] of the other user (referred to as user 2) are supplied to the user direction/distance calculator 142 from the video processing unit 141. Here, w in the face size represents the width of the rectangular area for face detection and h in the face size represents the height of the rectangular area for face detection.

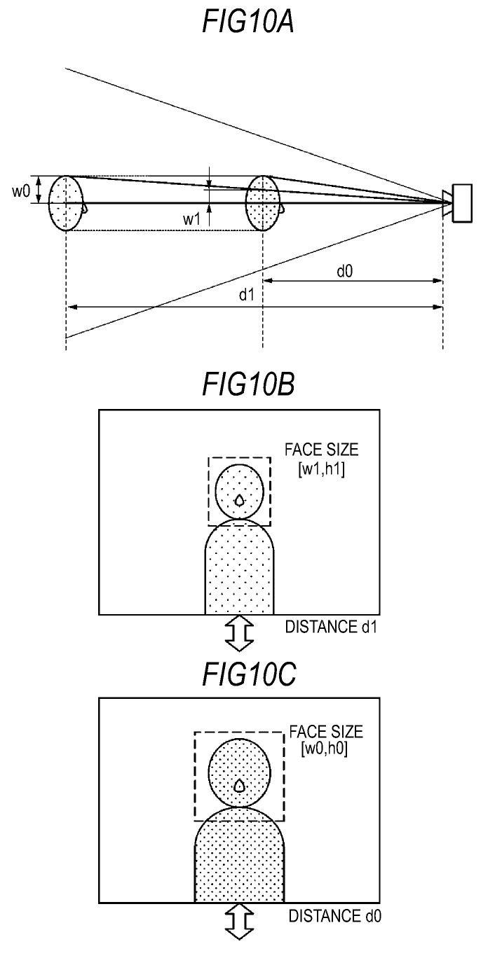

FIGS. 10A, 10B, and 10C show the relationship between the face size and the distance. FIG. 10A shows a case where users are present as a reference distance d0 and a distance d1. FIG. 10B is a diagram illustrating the face size [w1, h1] of the user at the distance d1. FIG. 10C is a diagram illustrating the reference face size [w0, h0] of the user at the reference distance d0.

The direction [φ1, φ1] is calculated by the following expression from the face detection position [a1, b1] normalized with a captured image size [xmax, ymax] and the viewing angle [φ0, φ0] of the camera of the sensor 101.
Horizontal direction: φ1=φ0×a1
Vertical direction: φ1=θ0×b1

The distance d1 is calculated by the following expression from the reference face size [w0, h0] at the reference distance d0.
Distance: d=d0×(w0/w1)

The user position information calculator 144 receives the calculation result of the relative position of the user relative to the optical axis of the camera of the sensor 101 from the user direction/distance calculator 142. The three-dimensional positions of the users about the center of the television receiver 100 and the front axis are calculated using attachment information (position/angle) of the sensor 101. By these processes, position information of the viewer (the number of persons, the horizontal angle, the distance, and the vertical angle) is output as the viewer position information from the CEC communication unit 115. When plural viewers are detected, the position information of each of the viewers is transmitted.

### <Viewer Position Information and CEC Communication>

The viewer position information is always calculated when the sensor 101 can operated in the state where the television receiver 100 is turned on. The maximum number of persons recognizable (detectable) is five. Regarding the detection range, the horizontal angle is in the range of −30° to +30° about the front axis of the sensor 101. The right is defined as—when viewing the screen of the television. The vertical angle is in the range of −25° to +25°. The distance is in the range of 0 cm to 620 cm. The viewer position information is broadcast-transmitted every 20 seconds by the CEC communication. 20 seconds is an example. Preferably, the time interval is set not to be equal to the interval at which the television receiver 100 periodically check the presence of a CEC device, for example, 15 seconds, as much as possible.

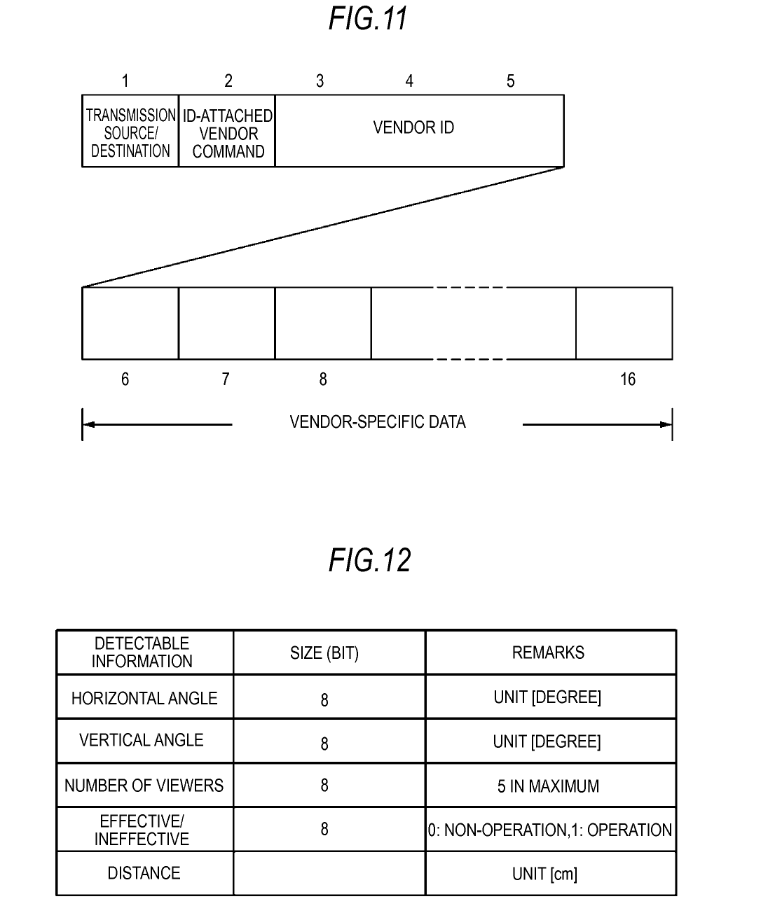

A CEC command used in the CEC communications includes a common command common to makers and a maker-specific command which can be freely developed by each maker. The maker-specific command has a configuration in which 1 packet is constructed by 16 bytes, as shown in FIG. 11. The first 1 byte includes transmission source/destination data, the next 1 byte includes an ID-attached vendor command, and the next 3 bytes include a vendor ID. The maker is specified by the vendor ID. Vendor specific data is located thereafter. The data of viewer position information is inserted into the sixth byte to the sixteenth byte.

A more specific example of the viewer position information is shown in FIG. 12. The horizontal angle information has a unit of degree (°) and a value in the range of −90° to +90° and is information for each viewer. The vertical angle information has a unit of degree (°) and a value in the range of −90° to +90° and is information for each viewer. The maximum number of viewers is 5. Effective/ineffective data is data indicating whether the sensor 101 detects a viewer. The distance is a distance in the front axis of the sensor 101 and has a unit of cm. An average of information of plural viewers may be transmitted to reduce an amount of data to be transmitted. For example, the average of vertical angle information of plural viewers is transmitted for the vertical angle.

### <Control Depending on Viewer Position in AV Amplifier>

The viewer position information is transmitted to the AV amplifier 300 from the television receiver 100 by the CEC communications. In the AV amplifier 300, a control signal is generated by the control signal generator 315 and the level and/or the amount of delay (phase) of the audio signal to be reproduced is adjusted by the DSP 313.

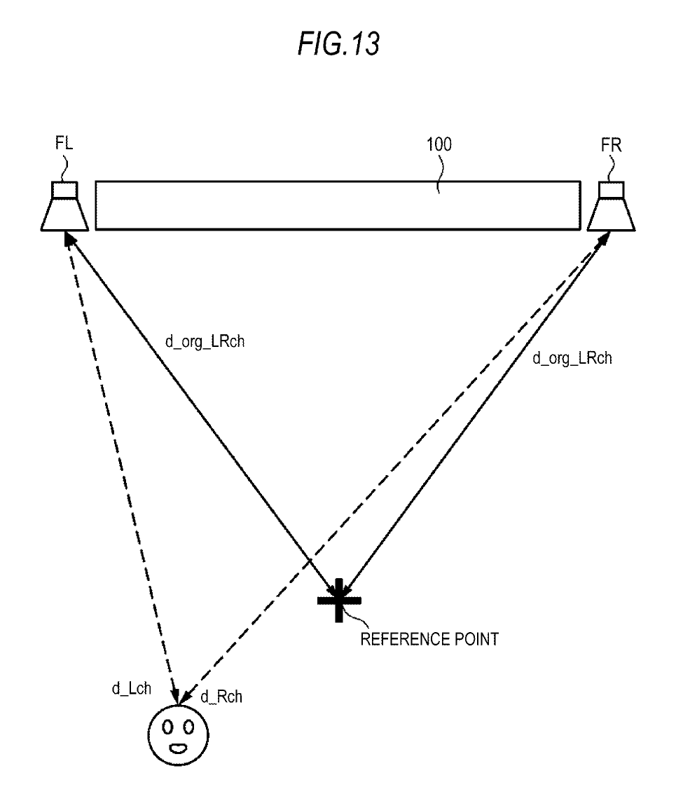

For example, a case where the balance in level between the audio signals of the right and left channels is optimized will be described with reference to FIG. 13. The volumes output from the right and left speakers FR and FL are the same as each other at the reference position. The reference point is a position apart by a predetermined distance from the center position (the position of the sensor 101) between the right and left speakers.

Since the levels of the audio radiated from the speakers FR and FL are attenuated in inverse proportion to the square of the distance, the difference from the reference position is calculated as follows and the volumes (gaindif) of the right and left speakers are calculated to optimize the right-left balance. In the following expressions, the logarithm means a common logarithm.

$$gainLch = 20 log ( \frac{dLch}{dorgLRch} )$$

$$gainRch = 20 log ( \frac{dRch}{dorgLRch} )$$

$$\begin{matrix}Gaindif = gainRch - gainLch \\ = 20 log ( dRch ) - 20 log ( dLch ) \\ = 20 log ( dLch / dRch )\end{matrix}$$

In the above expressions, the values represent the following.
gainLch: gain difference of L channel
gainRch: gain difference of R channel
dorgLRch: distance from right and left speakers FR and FL to reference point
dLch: distance from speaker FL to viewer
dRch: distance from speaker FR to viewer
gaindif: voltage gain difference of L/R

A current balance and a target balance are defined to optimize the balance. The current balance is a present balance value and the initial value is 0.0 dB. The target balance is a balance value as a target of the automatic adjustment and the initial value is 0.0 dB. When there are plural viewers, the target balance is calculated for the positions of the centers of gravity of the faces of the plural viewers. In the 2.1ch front surround-sound system and the 3.1ch front surround-sound system, the current balance and the target balance are calculated for the right and left channels.

The average values (the positions of the center of gravity) in the X and Y directions are calculated from the face position information of plural viewers. The target balance values are calculated on the basis of the distances between the positions of the centers of gravity of the viewers and the speakers FR and FL.
Balance value=20 log(distance from L speaker FL/distance from R speaker FR)

As described above, the viewer position information (the distance in the front axis and the horizontal angle of the viewer position about the center position (the sensor 101) of the speakers) of the viewers is transmitted from the television receiver 100 to the AV amplifier 300 as an HDMI-CEC maker-specific command. Therefore, the differences in gain between the audio signals of the right and left channels from the reference point can be optimized using the received viewer position information.

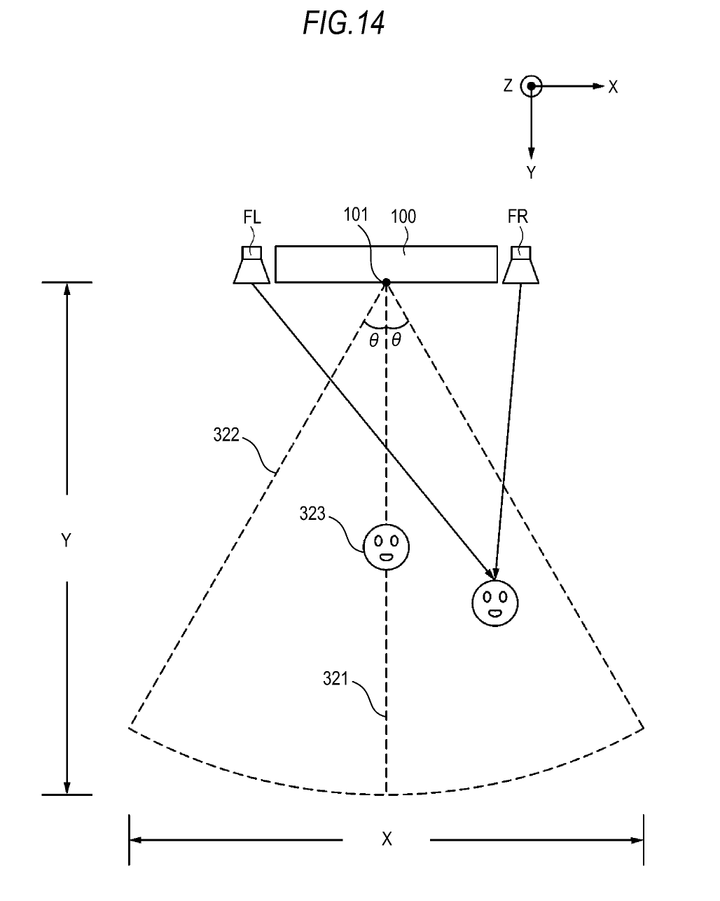

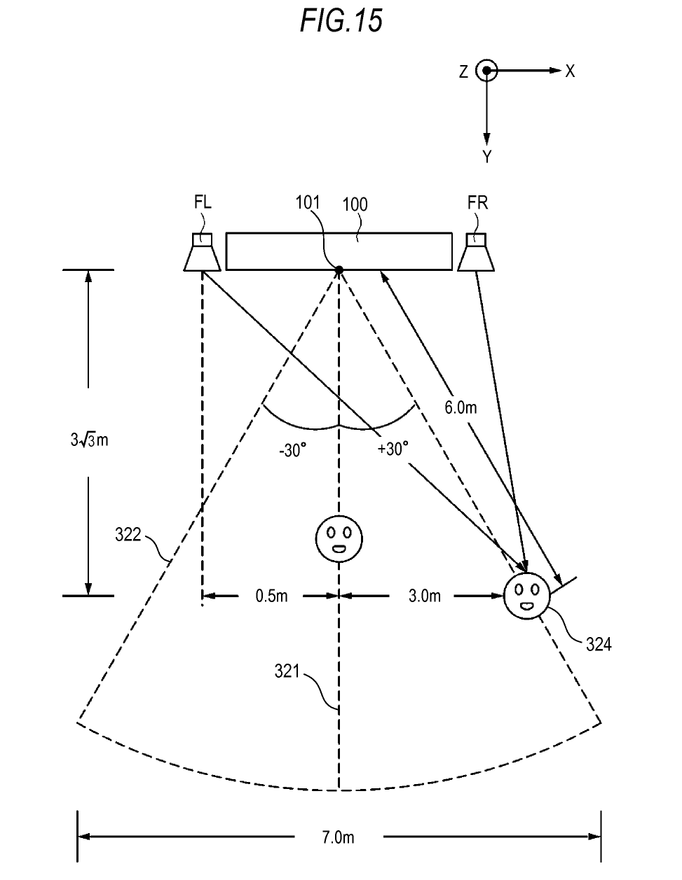

As shown in FIGS. 14 and 15, a fan-shaped detectable range 322 and a reference point 323 are set about a front axis 321 of the sensor 101. For example, θ=±30° is set, the distance Y from the sensor 101 is set to about 6.0 m, and the spreading range X is set to about 7.0 m. The balance representing (the level of the L channel-the level of the R channel) by 0.5 dB is used as a parameter. Since the excessive adjustment is unnatural, the maximum amount of balance adjustment is limited to 2 dB. That is, the balance+2 dB means a process of attenuating the level of the right channel by −2.0 dB and the balance −2 dB means a process of attenuating the level of the left channel by −2.0 dB.

A specific example where the right-left balance is automatically adjusted is shown in FIG. 15. The calculation of the target balance at a position 324 with a distance of 6.0 m from the television receiver 100 and with an angle of +30° will be described below. The distances of the speakers FR and FL from the sensor 101 are set to 0.5 m.
Distance to speaker FL: √(3√3)²+(3+0.5)²=6.26 m
Distance to speaker FR: √(3√3)²+(3−0.5)²=5.77 m
LR level difference (balance value)=20 log(6.26/5.77)=0.71 dB

When the distances of the speakers FR and FL from the sensor 101 are 1.5 m, the following is obtained.
Distance to speaker FL: √(3√3)²+(3+1.5)²=6.87 m
Distance to speaker FR: √(3√3)²+(3−1.5)²=5.41 m
LR level difference (balance value)=20 log(6.26/5.77)=2.08 dB (which is limited to 2.0 dB)

Since the above-mentioned method employs trigonometrical functions, the process load of the CPU of the control unit is heavy. The detection range 322 may be divided into areas (blocks) with a predetermined size and the balance value of the respective blocks may be calculated in advance and may be stored as a table in a nonvolatile memory. For example, the detection range 322 is divided by an interval of 0.5 m. When an area to which a viewer position belongs is determined, the balance value of the corresponding area can be read from the table at once. This simple method can reduce the processing load.

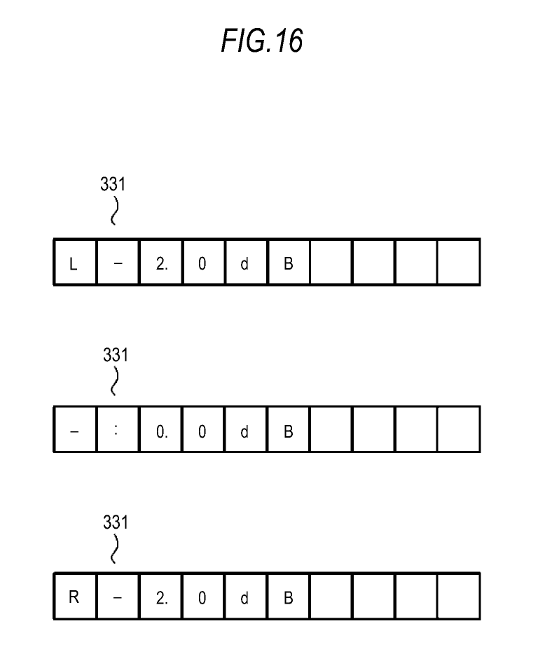

In the automatic viewer position adjustment mode, the current balance may be displayed in a line display part 331 disposed in the theater stand 200 for a user, as shown in FIG. 16. The user can check the display of the current balance value, for example, by setting a predetermined mode, for example, a test mode. In FIG. 16, the upper side represents a display when a viewer is detected at a position close to the left end. A reaction when the current balance is +2.0 dB is displayed. The middle side represents a display when a viewer is detected at the center. In this case, it is displayed that the current balance is +0.0 dB. The lower side represents a display when a viewer is detected at a position close to the right end. A reaction when the current balance is −2.0 dB is displayed.

### <Operation of Automatic Viewer Position Adjustment Mode>

The automatic viewer position adjustment mode (simply referred to as function) may include a state where it does not operate in view of a product specification. Examples thereof include the followings.
when setting of a sound field in which an input signal is output without any change
when a headphone is inserted
during environment setting operation such as when during output of test tone, and during automatic setting of a sound field
when automatic calibration is performed
when the present function is limited otherwise

When the viewer position information is received from the television receiver 100 while the present function is being inhibited in operation, the target balance is updated, but the current balance is temporarily to 0.0 dB and not changed. When the viewer position information is received in the meantime, the target balance is set during the inhabitation in operation and a current balance other than the current balance actually set to 0.0 dB is set. When the inhabitation in operation is released, the operation is restarted on the basis of the current balance.
When the gains of the speakers exceed the adjustment width due to factors other than the present function such as a level adjusting function or a balance adjusting function for each speaker, the level adjustment of the present function is limited to the possible range.
When the speakers and the like are protected, the present function does not operate
when various speaker levels can be set by the use of a separate user interface, the control based on the present function does not change its setting.
When an audio is output from the “television speaker” under the system audio control of the CEC, the control based on the present function is continued.

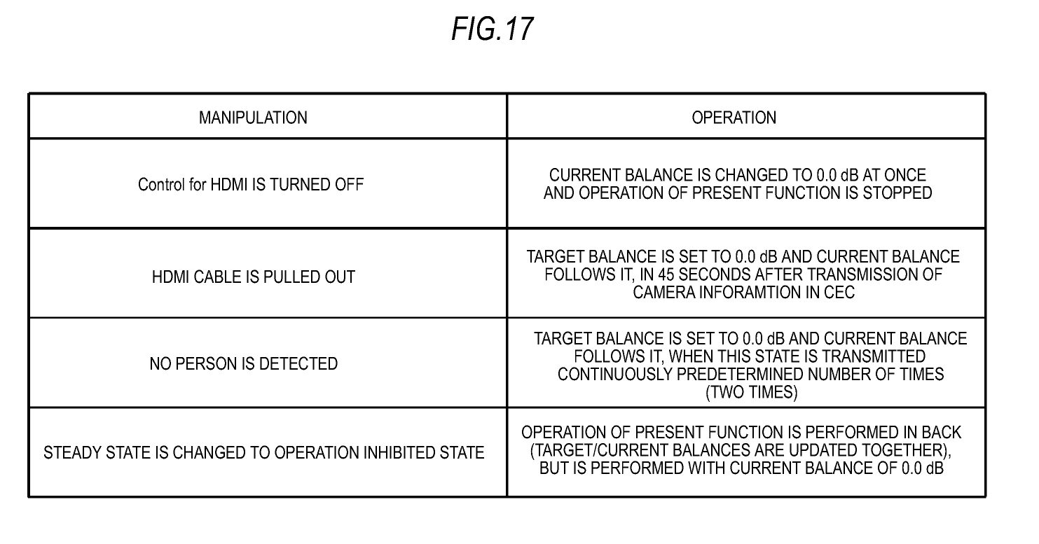

The operations corresponding to the manipulations are collectively shown in FIG. 17. When the HDMI control of the AV amplifier is turned off, the current balance is changed to 0.0 dB at once to stop the operation of the present function.

When the HDMI cable is pulled out, the target balance is changed to 0.0 dB in 45 seconds after the notification of the viewer position information in the CEC, and the current balance follows it.

When no person is detected and this state is notified continuously by a predetermined number of times (for example, two times), the target balance is changed to 0.0 dB and the current balance also follows it.

When a steady state is changed to the operation inhibited state, the operation of the present function is performed in the back (the target balance and the current balance are undated together), but the present function operates with the current balance of 0.0 dB.

### <Flow of Processes When AV Amplifier Receives Command>

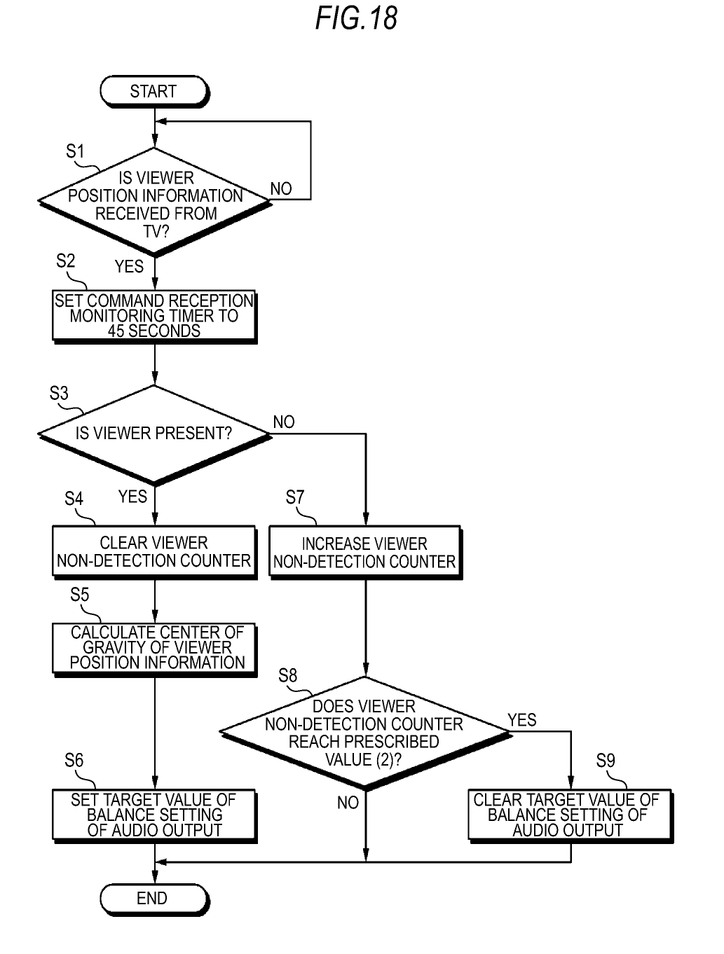

The flow of process of the AV amplifier 300 when receiving a command will be described below with reference to the flowchart shown in FIG. 18. In step S1, it is determined whether the viewer position information is received from the television receiver 100. When the viewer position information is received, a command reception monitoring timer is set to 45 seconds in step S2. The viewer position information is transmitted from the television receiver 100, for example, every 20 seconds.

In step S3, it is determined whether a viewer is detected from the viewer position information. When a viewer is detected, a viewer non-detection counter is cleared in step S4. In step S5, the center of gravity of the viewer position information is calculated. The center of gravity is treated as the current viewer position. In step S6, the target balance value in setting a balance of the audio output is set in step S6.

When it is determined in step S3 that a viewer is not detected, the viewer non-detection counter increases in step S7. In step S8, it is determined whether the count value of the viewer non-detection counter reaches a prescribed value (for example, 2). When the count value does not reach the prescribed value, the flow of processes is ended. When it is determined that the count value reaches the prescribed value, the target balance value in setting a balance of the audio output is cleared in step 9.

In this way, when the count value of the viewer non-detection counter reaches the prescribed value (for example, 2), it is determined that, for example, a face cannot be detected. The reason is that the case where the television receiver 100 cannot detect a face since a viewer bows his or her head is considered. In this way, when a face is not detected sometimes at the time of communication performed after 20 seconds, the target gain of the AV amplifier is changed to 0.0 dB and the value is fixed up to the time of transmitting data after 20 seconds. To avoid this situation, the target gain is set to 0.0 dB only when information indicating that no person is detected and this state is detected continuously by two times.

### <Regular Flow of Processes Every 1 Second>

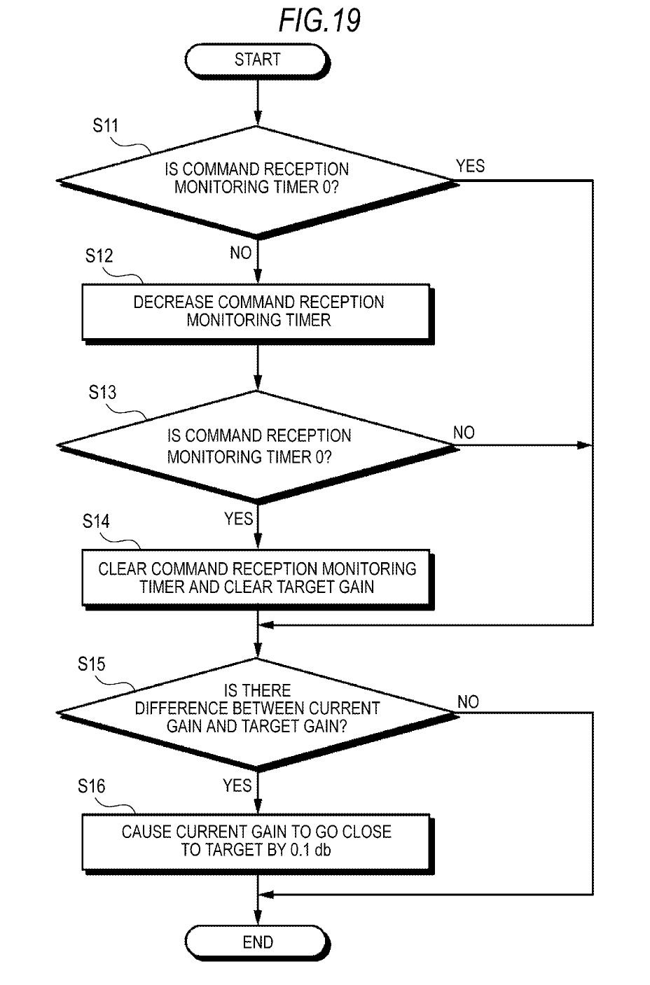

The flow of processes every second will be described below with reference to the flowchart shown in FIG. 19. In step S11, it is determined whether the command reception monitoring timer is 0. When it is determined the command reception monitoring timer is not 0, the command reception monitoring timer decreases in step S12. That is, the count value is changed by −1 every second. In step S13, it is determined whether the command monitoring timer is 0. When it is determined that the command monitoring timer is 0, the command reception monitoring timer is cleared and the target balance is cleared in step S14.

When it is determined in step S13 that the command monitoring timer is not 0 or after step S14, it is determined in step S15 whether there is a difference between the current gain and the target gain. When it is determined that there is no difference therebetween, the flow of processes is ended. When it is determined that there is a difference therebetween, the current gain goes close to the target gain by 0.1 dB in step S16.

As described above, when receiving the viewer position information, the command reception monitoring timer is set to 45 seconds. When a command is not received for 45 seconds, the process of step S14 is performed and thus the target balance is cleared. That is, when determining that the position information is not periodically notified, the AV amplifier returns the gain as a target to the steady state. When the balance goes close to the target balance, the balance goes gradually like 0.1 dB/sec. The regular flow of processes every second is necessary for detecting the case where the HDMI cable is pulled out, the case where the television receiver is turned off, the case where the HDMI device control setting in the television receiver is turned off, and the like.

<Flow of Process when HDMI Device Control Setting is Switched in AV Amplifier>

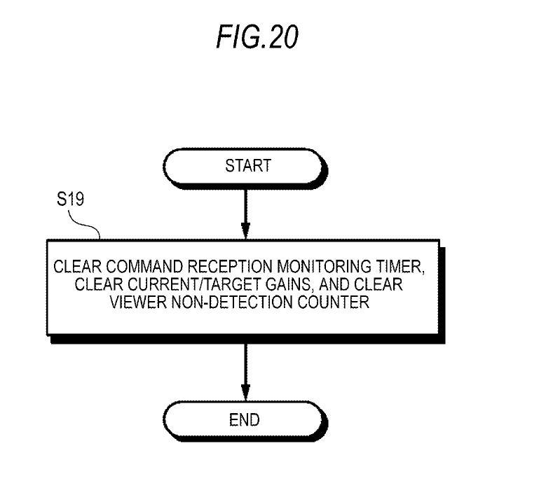

The flow of processes when the HDMI device control setting in the AV amplifier is switched from ON to OFF will be described below with reference to the flowchart shown in FIG. 20. In this case, since a command is not notified from the television receiver 100 for 45 seconds or more, the command reception monitoring timer is cleared, the current balance and the target balance are cleared, and the viewer non-detection counter is cleared in step S19, and thus the flow of processes is ended.

<Flow of Processes when Television Receiver is Turned On>

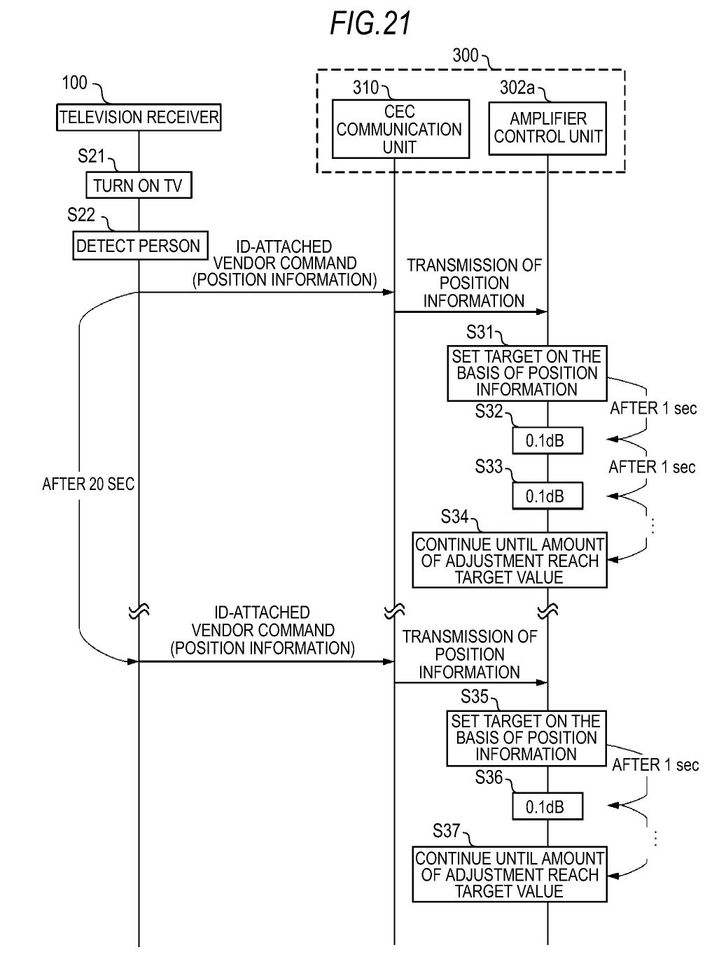

The flow of processes when the television receiver 100 is turned on will be described below with reference to FIG. 21. In FIG. 21 and FIGS. 22 to 25, data transmission between the television receiver 100 and the AV amplifier 300 (the CEC communication unit 310 and an amplifier control unit 302a) is shown. The CEC communication unit 310 and the amplifier control unit 302a communicate with each other by internal communications.

When the television receiver 100 is turned on (step S21), a person is detected in step S22. As a result, the viewer position information, that is, the ID-attached vendor command (position information) is transmitted to the CEC communication unit 310 of the AV amplifier 300. The viewer position information is supplied to the amplifier control unit 302a by the internal communications.

The amplifier control unit 302a sets the target balance on the basis of the position information (step S31). The adjustment is performed at a rate of 0.1 dB/sec (steps S32 and S33). The adjustment is gradually performed until reaching the target balance (step S34).

After 20 seconds, the ID-attached vendor command (position information) is transmitted to the CEC communication unit 310 of the AV amplifier 300 from the television receiver 100. The viewer position information is supplied to the amplifier control unit 302a by the internal communications. As described above, the target balance is set on the basis of the position information in step S35 and the adjustment is gradually performed until the amount of adjustment reaches the target balance in steps S36 and S37.

<Flow of Processes when AV Amplifier is Turned On>

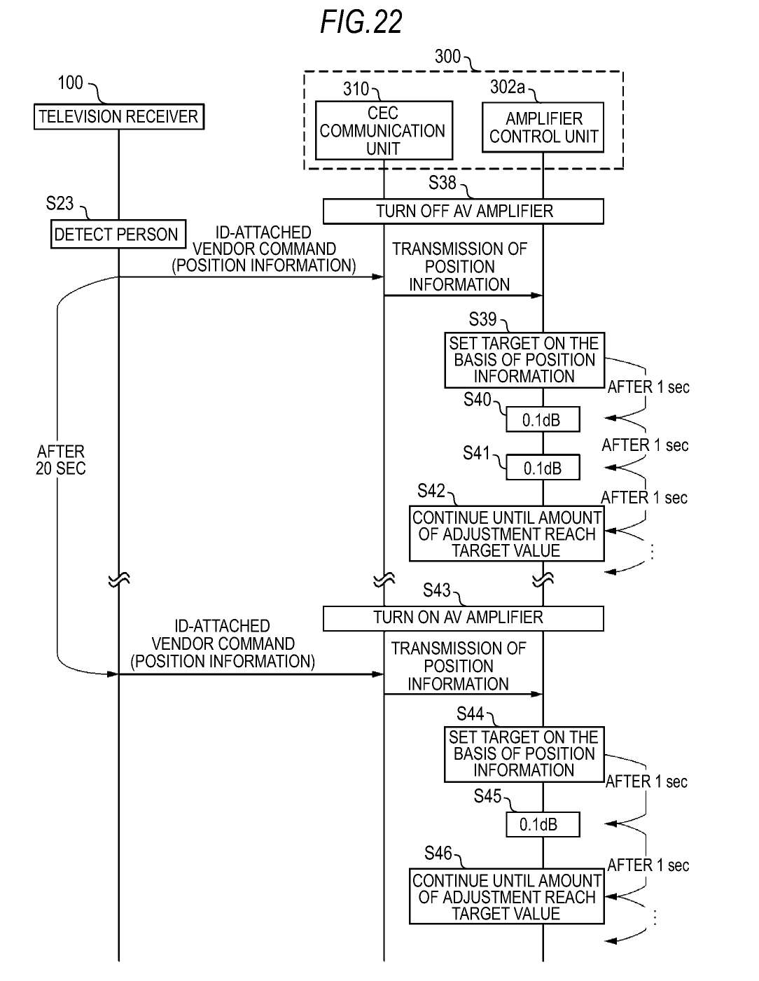

The flow of processes when the AV amplifier 300 is turned on will be described below with reference to FIG. 22. The television receiver 100 detects a person in step S23. As a result, the viewer position information, that is, the ID-attached vendor command (position information) is transmitted to the CEC communication unit 310 of the AV amplifier 300. The viewer position information is supplied to the amplifier control unit 302a by the internal communications.

The AV amplifier 300 is turned off in step S38. The CEC communication unit 310 and the amplifier control unit 302a are operable. The ID-attached vendor command (position information) is transmitted to the CEC communication unit 310 of the AV amplifier 300. The viewer position information is supplied to the amplifier control unit 302a by the internal communications.

The amplifier control unit 302a sets the target balance on the basis of the position information (step S39). The adjustment is performed at a rate of 0.1 dB/sec (steps S40 and S41). The adjustment is gradually performed until reaching the target balance (in step S42).

Then, the AV amplifier 300 is turned on in step S43. In 20 seconds after the position information is notified previously, the ID-attached vendor command (position information) is transmitted to the CEC communication unit 310 of the AV amplifier 300 from the television receiver 100. The viewer position information is supplied to the amplifier control unit 302a by the internal communications. As described above, the adjustment is gradually performed until the amount of adjustment reaches the target balance in steps S44, S45, and S46.

<Flow of Processes when No Person is Detected>

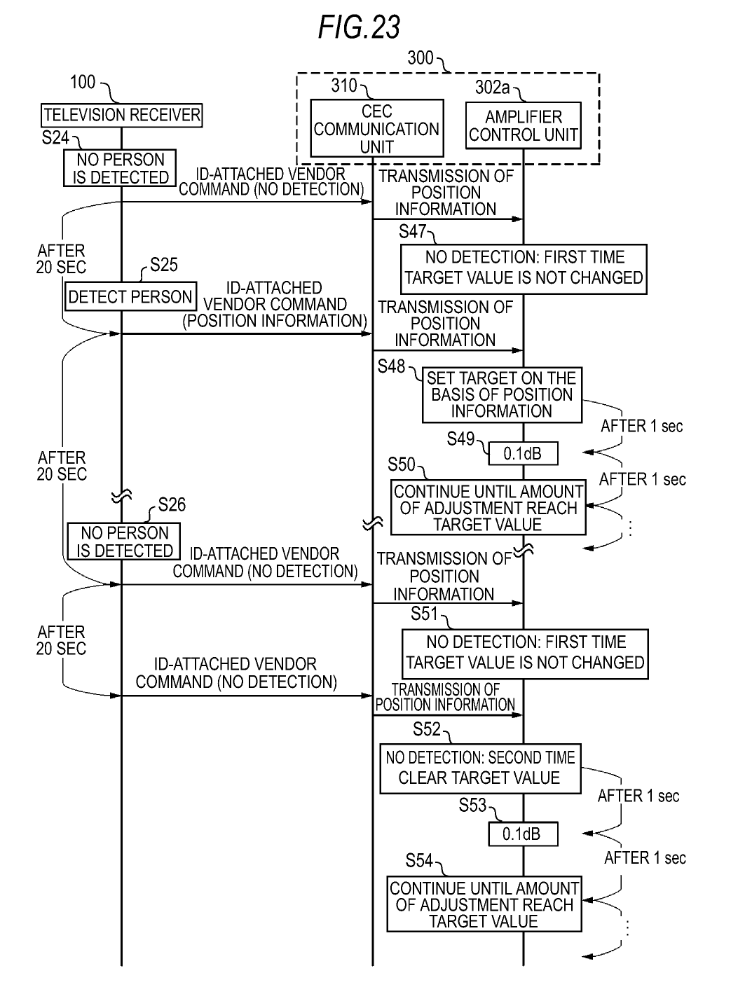

The flow of processes when no person is detected will be described below with reference to FIG. 23.

The television receiver 100 detects a person. As a result, when it is determined in step S24 that no person is detected, the ID-attached vendor command (no detection) is transmitted to the CEC communication unit 310 of the AV amplifier 300. This command is supplied to the amplifier control unit 302a by the internal communications.

The amplifier control unit 302a does not change the target balance value in step S47, since no person is detected at the first time. The television receiver 100 detects a person in step S25. As a result, the viewer position information, that is, the ID-attached vendor command (position information) is transmitted to the CEC communication unit 310 of the AV amplifier 300. The viewer position information is supplied to the amplifier control unit 302a by the internal communications.

The amplifier control unit 302a sets the target balance on the basis of the position information (step S48). The adjustment is performed at a rate of 0.1 dB/sec (step S49). The adjustment is gradually performed until the amount of adjustment reaches the target balance (in step S50).

When it is determined that no person is detected by the television receiver 100 (step S26) and a command indicating the purport is notified to the AV amplifier 300 continuously two times, the target balance is not changed in step S51, but it is determined in step S52 that no detection is notified continuously two times and the target balance is cleared. The adjustment is performed through the communications by the steps of 0.1 dB until the amount of adjustment goes close to the target balance in steps S53 and S54.

<Flow of Processes when Position Information is not Notified>

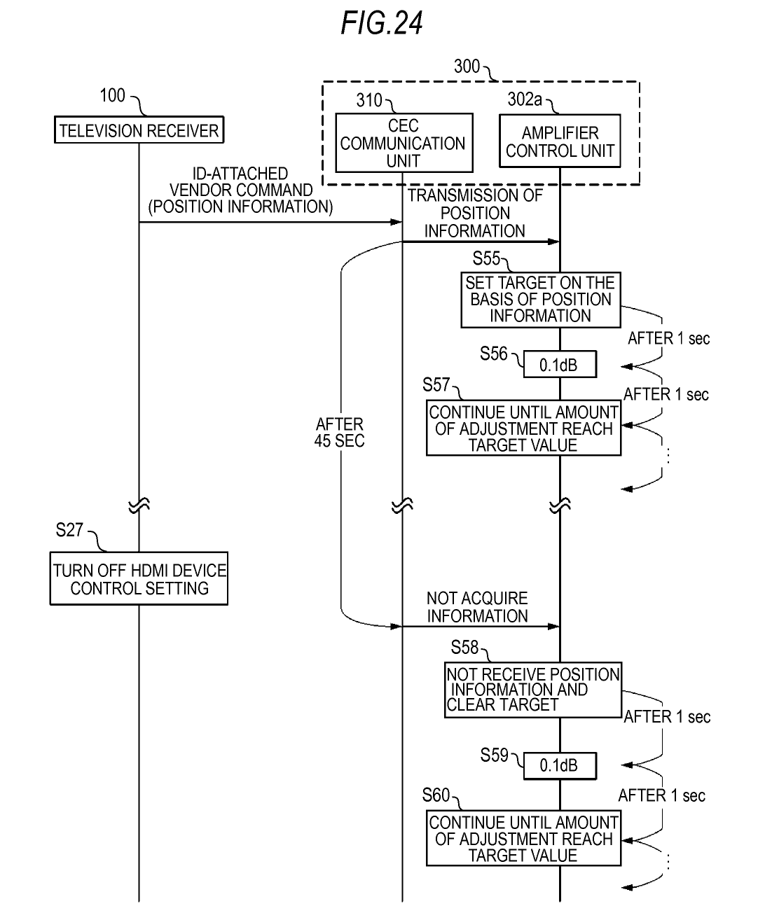

The flow of processes when the position information is not notified will be described below with reference to FIG. 24.

The ID-attached vendor command (position information) is transmitted to the CEC communication unit 310 of the AV amplifier 300 from the television receiver 100. The viewer position information is supplied to the amplifier control unit 302a by the internal communications.

The amplifier control unit 302a sets the target balance on the basis of the position information (step S55). The adjustment is performed at a rate of 0.1 dB/sec (step S56). The adjustment is gradually performed until the amount of adjustment reaches the target balance (in step S57).

In step S27, the HDMI device control setting of the television receiver 100 is turned off. As a result, the position information is not transmitted to the AV amplifier 300. Accordingly, the AV amplifier 300 does not acquire the position information for 45 seconds. As a result, since the position information is not received, the target balance is cleared in step S58. The adjustment is gradually performed until the amount of adjustment reaches the target balance (steps S59 and S60).

<Flow of Processes when HDMI Device Control Setting of AV Amplifier is Turned Off>

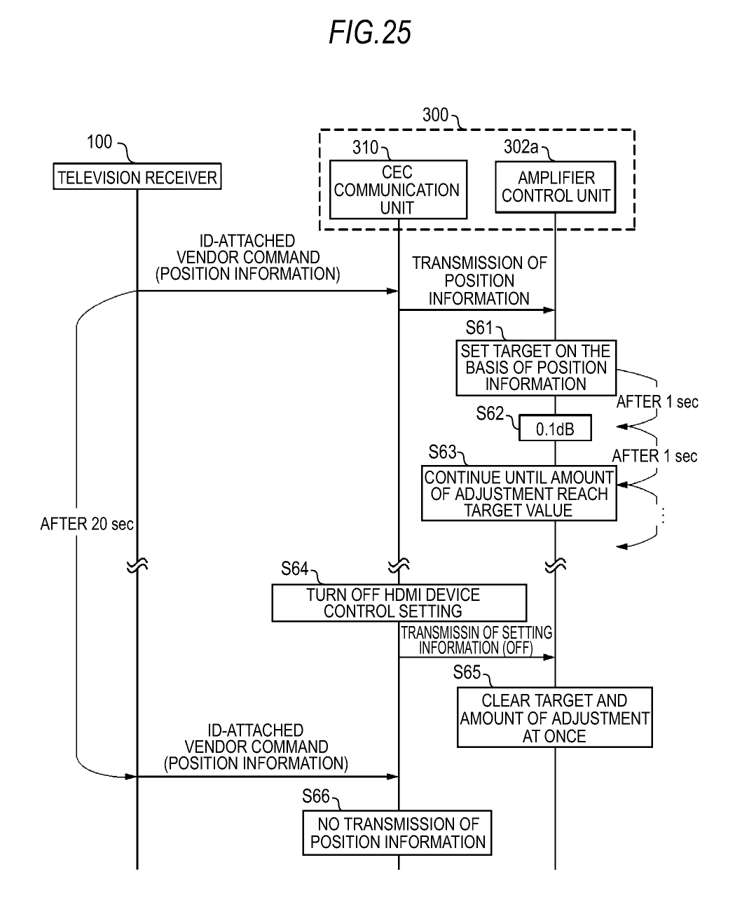

The flow of processes when the HDMI device control setting of the AV amplifier is turned off will be described below with reference to FIG. 25. The ID-attached vendor command (position information) is transmitted to the CEC communication unit 310 of the AV amplifier 300 from the television receiver 100. The viewer position information is supplied to the amplifier control unit 302a by the internal communications.

The amplifier control unit 302a sets the target balance on the basis of the position information (step S61). The adjustment is performed at a rate of 0.1 dB/sec (step S62). The adjustment is gradually performed until the amount of adjustment reaches the target balance (in step S63).

In step S64, the HDMI device control setting of the AV amplifier 300 is turned off. As a result, the setting information (OFF) is transmitted to the amplifier control unit 302a. The amplifier control unit 302a having been notified of the setting information clears the target balance and the amount of adjustment at once in step S65. On the other hand, after 20 seconds, the television receiver 100 outputs the position information to the AV amplifier 300. Even when receiving the position information, the CEC communication unit 310 does not transmit the position information to the amplifier control unit 302a (step S66).

### Embodiments of the Present Disclosure

Preferred embodiments of the present disclosure are as follows.

According to an embodiment of the present disclosure, there is provided an audio device including: a reproduction unit that reproduces an audio signal of a plurality of channels; an input unit that receives a detection signal indicating the positions of the reproduction unit and a listener; and a control unit that changes the audio signal to be reproduced by the reproduction unit depending on the position based on the detection signal.

In the audio device according to the embodiment, the control unit may calculate a target value of a level and/or an amount of delay of the audio signal on the basis of the position and may change the level and/or the amount of delay of the audio signal using a difference between the target value and a current value as an amount of adjustment.

In the audio device according to the embodiment, the control unit may divide the amount of adjustment into smaller steps and may change the audio signal by the steps.

In the audio device according to the embodiment, the control unit may change the audio signal to be reproduced depending on the positions based on centers of gravity of the positions of a plurality of listeners.

In the audio device according to the embodiment, the control unit may clear the amount of adjustment when information indicating that no listener is detected is not received continuously by a prescribed number of times.

According to another embodiment of the present disclosure, there is provided an audio system including: a sensor that detects a position of a listener; a position detecting unit that processes output of the sensor and outputs a detection signal indicating the position; a reproduction unit that reproduces an audio signal of a plurality of channels; an input unit that receives the detection signal from the position detecting unit; and a control unit that changes the audio signal to be reproduced by the reproduction unit depending on the position based on the detection signal.

In the audio system according to the embodiment, the position detecting unit may be constructed by an imaging unit disposed in a video display device located almost at the same position as the reproduction unit.

### <Modifications>

While the embodiments of the present disclosure have been specifically described, the present disclosure is not limited to the embodiments but may be modified in various forms without departing from the technical concept of the present disclosure. An example where the volume level of the front speaker is adjusted has been described, but it may be possible to provide a sound field corresponding to the position of a viewer by automatically adjusting the volume levels of other speaker or the amounts of delay (the distance setting) of the speakers on the basis of the positional relationship between the speakers even in the surround-sound system of 5.1ch, 7.1ch, and the like. An AV amplifier realizing a more appropriate amount of delay by measuring the position of a viewer by the use of a microphone may be provided. By combining this position information with the set position, it may be possible to set a sound field more appropriately corresponding to the position of the viewer. Since the position of the viewer in the vertical direction can be detected in real time, the adjustment in the height direction may be carried out. The present disclosure is not limited to use of the HDMI-CEC interface, but may use other wired interfaces or wireless interfaces.

It should be understood by those skilled in the art that various modifications, combinations, sub-combinations and alterations may occur depending on design requirements and other factors insofar as they are within the scope of the appended claims or the equivalents thereof.

What is claimed is:

1. An audio device comprising:
a reproduction unit that reproduces an audio signal of a plurality of channels;
an input unit that receives a detection signal indicating the positions of the reproduction unit and a listener; and
a control unit that changes the audio signal to be reproduced by the reproduction unit depending on the position based on the detection signal.

2. The audio device according to claim 1, wherein the control unit calculates a target value of a level and/or an amount of delay of the audio signal on the basis of the position and changes the level and/or the amount of delay of the audio signal using a difference between the target value and a current value as an amount of adjustment.

3. The audio device according to claim 1, wherein the control unit divides the amount of adjustment into smaller steps and changes the audio signal by the steps.

4. The audio device according to claim 1, wherein the control unit changes the audio signal to be reproduced depending on the positions based on centers of gravity of the positions of a plurality of listeners.

5. The audio device according to claim 1, wherein the control unit clears the amount of adjustment when information indicating that no listener is detected is not received continuously by a prescribed number of times.

6. An audio system comprising:
a sensor that detects a position of a listener;
a position detecting unit that processes output of the sensor and outputs a detection signal indicating the position;
a reproduction unit that reproduces an audio signal of a plurality of channels;
an input unit that receives the detection signal from the position detecting unit; and
a control unit that changes the audio signal to be reproduced by the reproduction unit depending on the position based on the detection signal.

7. The audio system according to claim 6, wherein the position detecting unit is constructed by an imaging unit disposed in a video display device located almost at the same position as the reproduction unit.
